(19) United States
(12) Patent Application Publication
(10) Pub. No.: US 2006/0156003 A1
(43) Pub. Date: Jul. 13, 2006

(54) Watermarking digital data at a user device

(76) Inventors: Junbiao Zhang, Bridgewater, NJ (US); Kumar Ramaswamy, Princeton, NJ (US); Jun Li, Middlesex, NJ (US)

Correspondence Address: THOMSON LICENSING INC., PATENT OPERATIONS, PO BOX 5312, PRINCETON, NJ, 08543-5312, US

(21) Appl. No.: 10/524,656

(22) PCT Filed: Aug. 13, 2003
(86) PCT No.: PCT/US03/25488

§ 371 Date: Sep. 26, 2005

(30) Foreign Application Priority Data
Aug. 21, 2002 (US) 60404884

(51) Int. Cl. H04N 17/00

(52) U.S. Cl. 713/176

(57) ABSTRACT

A method of watermarking digital media data in a user device using a watermark that contains information derived from the digital media data content and the user device specific information to enable improved enforcement of the digital media data content copyright license.

This application claims the benefit of the U.S. Provisional Application No. 60/404/884 filed on Aug. 21, 2002.

### FIELD OF THE INVENTION

The present invention relates to digital media content protection, and more particularly, to a method of watermarking digital media data for the purpose of authenticating copyright ownership and copyright protection.

### BACKGROUND OF THE INVENTION

Multimedia data content protection is a very significant problem facing content providers. Current content protection methods rely on encryption to protect the multimedia data content with the assumption that only authorized users have the key to decrypt the encrypted multimedia data content. However, this does not prevent the user from taking the unencrypted and uncompressed signal from the user's device and re-encoding it for illegal distribution.

One method of copyright protection utilized in digital multimedia industry is watermarking of the digital multimedia signal (e.g. video and/or audio signals). A watermark is a digital code embedded in the bit stream of the digital multimedia signal which typically indicates the identity of the copyright owner. When watermarking is applied to individual copies of digital audio or video data, such as audio CDs or video DVDs, watermarking may also be used to indicate the identity of the licensed receiver of each copy. Then, illegally reproduced copies can be traced back to the original receiver.

In a known application for watermarking multimedia data, the watermark signal is uniquely defined by user device specific information. Typically, this would be the user device's unique machine ID. For example, some DVD player manufacturers incorporate watermarking engines in their DVD players so that a unique watermark is added into the uncompressed video output signal. The watermark contains the unique machine ID of the particular DVD player which generates the watermark signal. If the video from the output of the DVD player is then recorded, the recorded copy would be watermarked with information identifying the particular DVD player used to make the unauthorized copy.

However, using the machine ID alone to determine the watermark signal has some limitations. First, it is a static piece of information for each user device so it does not change. This dictates that the watermark signal will exhibit a relatively stable characteristic pattern for a given user device. Such pattern can be detected relatively easily and the watermark signal may be isolated and removed. Secondly, since the information contained in the watermark is limited, for example, to only the machine ID, the type of content distribution control based on such information is thus also quite limited.

Thus, improved watermarking methods are desired.

### SUMMARY OF THE INVENTION

According to an aspect of the present invention, there is disclosed a method of watermarking digital media data in a user device, such as a CD player, a DVD player, or a video set-top box where the watermark contains information derived from the digital media data content in addition to the user device specific information. Digital media data as used in this application may be multimedia data (i.e. including video and audio data) or video data alone or audio data alone. In a typical digital content distribution framework, media data, when received at the user device, is generally encrypted for protection. In order to decrypt the content, the user device typically needs to obtain a copyright license from the digital media content provider. The copyright license is normally provided separate from the content and includes a key to decrypt the content. The copyright license may also contain information that is used to control the playback of the content. For example, the license may specify which machine the license is limited to and the expiration date of the license. After decrypting the digital media data, the user device will decode to uncompress the digital media data. Then, the user device will use both the information contained in the license data and the user device's unique identification information to generate a watermark. The watermark is then embedded into the decrypted and uncompressed digital media content. There are a number of signal processing methods, well known in the art, for the generation of a watermark and embedding of a watermark into a host signal. Any such methods may be employed in this invention.

Watermarking digital media data using a watermark that includes information derived from the digital media data content and an user device specific information provides a number of benefits to the copyright protection scheme in digital content distribution framework. Firstly, it provides the digital media data content providers an opportunity to be more involved in the content protection process. Since content providers are often the parties most concerned about content protection, enhancing their ability to better control the process is desirable. Secondly, the watermark that is embedded in the output signal of the user device will contain more comprehensive information than that found in the conventional watermarking scheme. For example, the watermark generated according to an embodiment of the present invention contains user device specific information, such as the device's unique machine ID, and information derived from the copyright license associated with the digital media data content. The copyright license related information would include subscriber/buyer information, any rules that regulate the use of the digital media data content, such as, for example, the specific device for which the digital media data content is intended, the expiration date of the copyright license, whether the digital media data content can be redistributed (distribution rights), what geographical locations can view the digital media data content (geographical limitations), as well as the content provider information. Such comprehensive content-related information can be used to determine the origin of the digital media data content, the targeted devices of the digital media data content and the lifetime of the digital media data content, which may be used for more effective copyright protection of the digital media data content.

The watermarking method according to an aspect of the present invention can be used by the digital media data content providers to more effectively detect copyright infringement and trace the origin of the infringement. Since comprehensive content-related information (including content provider information and content distribution rights) is embedded in the content as part of the watermark together with the user device ID, content providers can easily track their contents by searching for the watermark pattern related to their unique information. Once such contents are located, the digital media data content providers can then determine whether the contents are distributed as specified by the original distribution rights. If a piece of digital media content is an illegal copy, the culprit device, as well as the identity of the content from which the illegal distribution originated, can be identified using the content-related information in the watermark signal.

### BRIEF DESCRIPTION OF THE DRAWING

The invention will be better understood from the following detailed description of an exemplary embodiment thereof in conjunction with the accompanying drawing in which:

FIG. 1 is a schematic representation of a user device capable of performing a method of watermarking digital media data according to an embodiment of the present invention.

### DETAILED DESCRIPTION

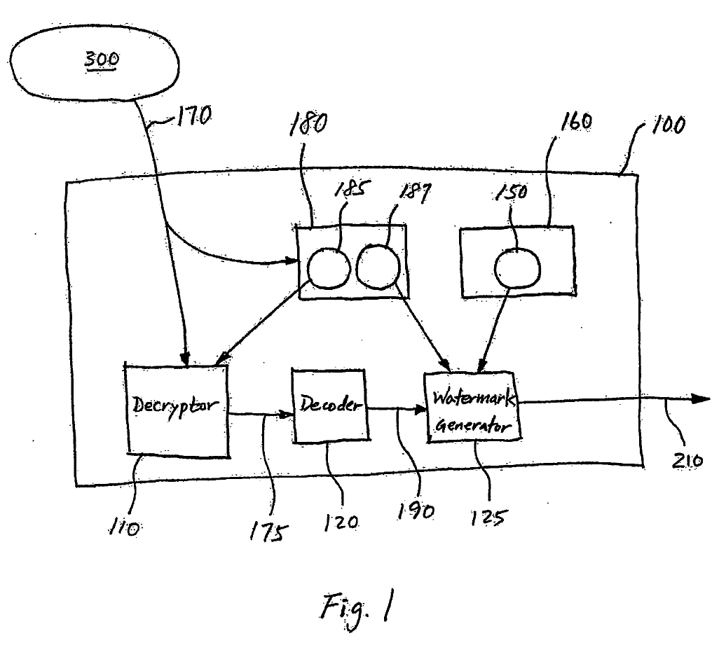

Referring to FIG. 1, a user device 100 according to an embodiment of the present invention is schematically illustrated. The user device 100 is provided with a decryptor 110 for decrypting a digital media data and a decoder 120 for decoding the decrypted digital media data and watermark generator 125 for generating and embedding a watermark signal into the decrypted and uncompressed digital media data. The user device 100 is typically assigned a user device specific indicator. In this example, that indicator is a unique machine ID 150 assigned by the manufacturer. The user device 100 may be provided with a memory unit 160 in which the machine ID 150 is stored.

In an exemplary application, the user device 100 receives an encrypted digital media data signal 170 from a digital media data content provider 300. A decryptor 110 decrypts the encrypted digital media data signal 170 into a decrypted digital media data signal 175. The decrypted digital media data signal 175 is then decoded and uncompressed by a decoder 120. A watermark generator 125 then embeds a watermark signal to the uncompressed digital media data signal 190 from the decoder 120 to produce a final output signal 210 which can be viewed or recorded by the user. In another embodiment of the present invention, the decoder 120 and the watermark generator 125 may be a single device that combines the two functions.

In order for the user device 100 to decrypt the digital media data signal 170, the user device 100 requires a copyright license from the digital media data provider 300. The digital media data content provider 300 provides copyright license data 180 along with an encrypted digital media data signal 170. The copyright license data 180 typically includes a decryption key 185 for decrypting the digital media data signal 170. A decryptor 110 uses the decryption key 185 to decrypt the digital media data signal 170.

The copyright license data 180 includes digital media data content-related information 187. The digital media data content-related information 187 comprises information that is used to control the playback of the digital media data content. Some examples of the digital media data content-related information 187 are: the digital media data content subscriber/buyer (i.e. the user) information; identification of the digital media content provider; identification of the machine the license is limited to; expiration date of the license; content distribution rights; and geographical limitations. The digital media data content-related information 187 and the machine ID 150 of the user device 100 are processed by the watermark generator 125 to generate a watermark signal. The watermark generator 125 embeds the watermark signal into the decoded digital media data signal 190 using any one of the watermarking methods generally known in the art. The resulting final output signal 210 is unencrypted, uncompressed, and watermarked.

The final output signal 210 is watermarked with the watermark signal that was derived from information in the copyright license data 180 and the machine ID 150 of the user device 100. Such watermarking scheme enables digital media data content providers to identify the source of any illegally distributed copies of their digital media data content. When an ill-motivated user makes illegal copies of a digital media data content, for example, the user's device that was used to decrypt and play the original copy of the digital media data content will embed a watermark according to the present invention. And that watermark, having the user device's machine ID information as well as the digital media data content-related information, derived from the copyright license data, will allow the digital media data content provider to identify the original user (e.g. the subscriber or purchaser) of the digital media data content and the user device 100 that was used to make the illegal copies. Thus, even if the user device 100 is now in the possession of an unknown party, the source of the original copy of the content from which the unauthorized distribution began can be identified. Another benefit of the watermarking method according to the invention is that because the watermark is not always same for a given user device, it is generally less susceptible to being isolated and removed by a hacker.

In another embodiment of the present invention, the watermark signal also may contain information on the identity of the digital media data content owner. The digital media data content owner would generally be the owner of the copyright for the digital media data content.

Preferably, the type of watermark signal utilized in the watermarking scheme according to the invention is a robust type and not fragile. In other words, the watermark should survive further processing of the digital media data content signal after the watermark has been embedded. For example, if the watermarked uncompressed content data from the user device were to be further coded and decoded or encrypted and decrypted by copyright infringers, the watermark should survive and recognizable. Methods for generating such robust watermarks are well known in the art. Some examples of such methods are disclosed in INGEMAR J. Cox ET AL., DIGITAL WATRMARG 241-278 (Morgan Kaufmann Publishers 2002), the cited portion of which are incorporated herein by reference.

While the foregoing invention has been described with reference to the above embodiments, various modifications and changes can be made without departing from the spirit of the invention. Accordingly, all such modifications and changes are considered to be within the scope of the appended claims.

1. A method of watermarking digital media data at a user device comprising the steps of:
receiving encrypted digital media data;
decrypting the digital media data into decrypted data;
decoding the decrypted data into uncompressed data;
generating a watermark signal comprising a digital media data content-related information and a user device specific indicator; and
embedding the watermark signal into the uncompressed data.

2. The method of claim 1, wherein the digital media content-related information is derived from information contained in copyright license data corresponding to the digital media data.

3. The method of claim 2, wherein the copyright license data includes information that is used to control playback of the digital media data content.

4. The method of claim 1, wherein the user device specific indicator includes the user device's unique identification data.

5. The method of claim 1, wherein the watermark signal further includes information on the identity of the digital media data content owner.

6. The method of claim 2, wherein the digital media data content-related information includes the digital media data content subscriber information.

7. The method of claim 2, wherein the digital media data content-related information includes the expiration date of the copyright license.

8. The method of claim 2, wherein the digital media data content-related information includes information on distribution rights of the copyright license.

9. The method of claim 2, wherein the digital media data content-related information includes information on the geographical limitations on the copyright license.

10. The method of claim 1, wherein the digital media data is multimedia data.

11. A user device adapted and configured to receive encrypted digital media data;
decrypt the digital media data into decrypted data;
decode the decrypted data into uncompressed data;
generate a watermark signal comprising a digital media data content-related information and a user device specific indicator; and
embed the watermark signal into the uncompressed data.

12. The user device of claim 11, wherein the digital media data is multimedia data.

13. The user device of claim 11, wherein the digital media data content-related information is derived from information contained in a copyright license data corresponding to the digital media data.

14. The user device of claim 11, wherein the copyright license data includes information that is used to control playback of the digital media data content.

15. The user device of claim 13, wherein the digital media data content-related information includes the digital media data content subscriber information.

16. A method of enforcing a digital media data content's copyright license, comprising:
receiving a digital media data content at a user device;
decrypting the digital media data content into decrypted data in the user device;
decoding the decrypted data into uncompressed data in the user device;
receiving a copyright license data in the user device;
extracting at least one digital media data content-related information from the copyright license data;
generating a watermark signal comprising the at least one digital media content-related information and a user device specific indicator;
embedding the watermark signal into the uncompressed data;
identifying the watermark signal in a suspect copy of the digital media data content; and
determining whether the suspect copy of the digital media data content was distributed according to the copyright license data.

17. The method of claim 16, wherein the digital media data is multimedia data.

18. The method of claim 16, wherein the digital media data content-related information is derived from information contained in a copyright license data corresponding to the digital media data.

19. The method of claim 16, wherein the digital media data content-related information includes digital media data content subscriber information.

20. The method of claim 16, wherein the digital media data content-related information includes information that is used to control playback of the digital media data content.

21. The method of claim 16, wherein the user device specific indicator includes the user device's unique identification data.

22. The method of claim 16, wherein the digital media data content-related information includes the expiration date of the copyright license.

23. The method of claim 16, wherein the digital media data content-related information includes information on the distribution rights of the copyright license.

24. The method of claim 16, wherein the digital media data content-related information includes information on the geographical limitations on the copyright license.
